(19) United States
(12) Patent Application Publication
(10) Pub. No.: US 2020/0383861 A1
(43) Pub. Date: Dec. 10, 2020

(54) PRODUCTS COMPRISING ASH AND METHODS OF MAKING THE SAME

(71) Applicant: Brian Storts, Houston, TX (US)

(72) Inventor: Brian Storts, Houston, TX (US)

(21) Appl. No.: 16/433,013

(22) Filed: Jun. 6, 2019

(51) Int. Cl. A61G 17/08; B44C 3/06; A61G 17/007

(52) U.S. Cl. CPC A61G 17/08; A61G 17/007; B44C 3/06

(57) ABSTRACT

A resin based item comprising the cremation ashes of a human or animal is providing, along with the method of making the same. Other embodiments are also disclosed herein.

### FIELD OF THE INVENTION

The present invention relates generally to products that comprise ash and methods of making the same. More particularly, the present invention relates to products that comprise cremation ash and methods of making the same.

### BRIEF DESCRIPTION OF THE DRAWINGS

To facilitate further description of the embodiments, the following drawings are provided. The same reference numerals in different figures denote the same elements.

FIG. 1 illustrates an example of an embodiment of a keepsake comprising ash, in accordance with at least some embodiments.

FIG. 2 illustrates an example of an embodiment of a mold to shape a keepsake comprising ash, in accordance with at least some embodiments.

FIG. 3 illustrates an example of an embodiment of the mold and a mixture to create a keepsake comprising ash, in accordance with at least some embodiments.

FIG. 4 illustrates an example of a flow chart of a method of making a keepsake comprising ash, in accordance with at least some embodiments.

Like reference numbers and designations in the various drawings indicate like elements.

### DETAILED DESCRIPTION

In a number of embodiments, a keepsake can comprise: a keepsake mixture; ashes from the cremation of a deceased human or animal. The keepsake can be formed using a matrix and the ashes are relatively uniformly distributed throughout the keepsake.

In another embodiment, a method of creating a keepsake can comprise: choosing a matrix; creating a keepsake mixture; thoroughly mixing the keepsake mixture with ashes from the cremation of a deceased human or animal; applying the mixture of ashes and the keepsake mixture to the matrix; and allowing mixture of ashes and the keepsake mixture to cure to produce the keepsake. The keepsake can comprise a relatively uniform mixture of the keepsake mixture and ashes throughout the keepsake.

In yet another embodiment, an object can comprise a mixture of an aggregate and a primary mixture comprising at least two components. The aggregate can comprise ashes from the cremation of a deceased human or animal.

As more and more people choose cremation for their loved ones, their pets, and/or themselves upon death, there is an increasing number of ways to store or disperse of the cremated remains. Some traditional ways to handle the cremation ashes includes scattering the ashes, burying the ashes, storing the ashes, such as in an urn, planting the ashes, and even carrying around a portion of the ashes in a piece of jewelry.

Embodiments of the present invention as opposed to the above-mentioned items, comprise a keepsake that is produced in part from the cremations ashes, as opposed to being stored inside an item, such as, for example, an urn or piece of jewelry. In some embodiments, the keepsake is a product, such as, for example, a molded, or otherwise formed object predominately made from a combination of a mixture and ashes. The mixture can comprise, for example, a resin, concrete, plaster, or clay. It should be appreciated that these mixtures are merely exemplary and other types of mixtures can be used.

As an example, the ashes can be mixed with a resin to form a keepsake. In another example, the ashes can be combined with other ingredients that form concrete or plaster. In yet another example, the ashes can be combined with clay or similar product. In each example, the resin, plaster, concrete, or clay can be molded (or otherwise formed) to form a keepsake that comprises the ashes of the loved one or pet.

In some examples, the keepsake can be molded or shaped into the form of a pet animal that has died, such as a dog. Other examples can include a shape of a trophy that a pet animal may have won, statues that represent the interest of the person who has passed, home and garden decorations, a bench memorializing an individual, or any other form, that comprises the cremation ashes in combination with one or more other materials, as opposed to an object that merely stores or displays those ashes.

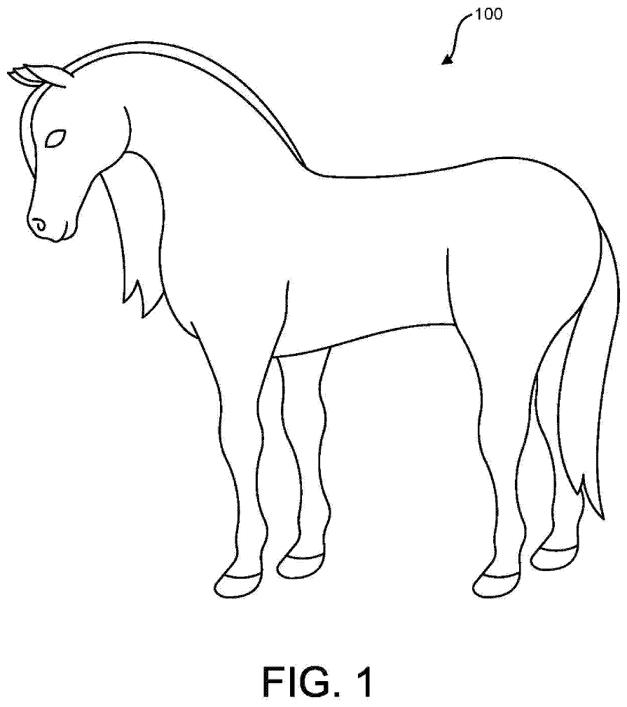

Turning to the drawings, FIG. 1 illustrates an example of a keepsake 100 according to one or more embodiments of the present invention. In the same or different embodiments, keepsake 100 can be considered a molded, sculpted, or otherwise formed product comprising cremation ashes. Keepsake 100 is exemplary and is not limited to the embodiments presented herein. Keepsake 100 can be employed in different embodiments not depicted or described herein.

Keepsake 100 comprises the cremation ashes of a deceased person or animal. In some examples, keepsake 100 can comprise a resin. Examples of a resin that can be used to create keepsake 100 can include an epoxy resin or polyester resin. It should be noted that other types of resin not specifically mentioned herein can also be used. In other examples, keepsake 100 can comprises concrete. In yet other examples, keepsake 100 can comprise plaster. It should be appreciated that keepsake 100 can comprise any material that can be molded, sculpted or otherwise formed, such as, for example clay. In the example of FIG. 1, keepsake 100 comprises the shape of a horse. The design of keepsake 100 is up to the designer. Any shape that yields a stable end product can be used.

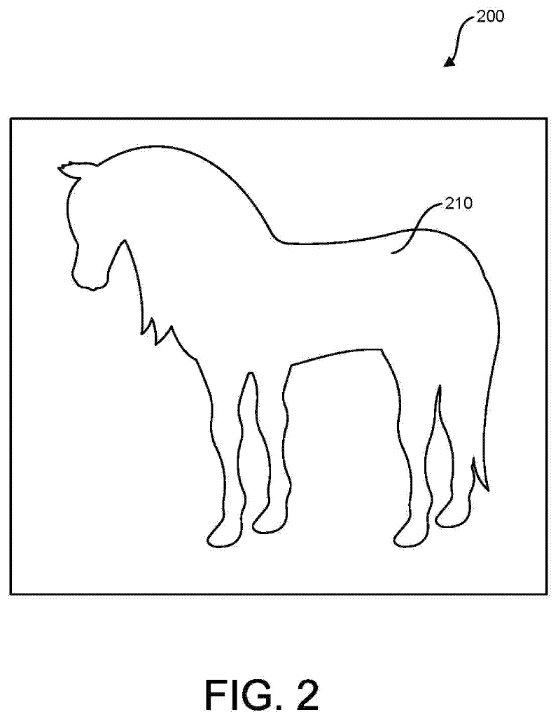

FIG. 2 illustrates an example of a matrix used to shape keepsake 100. In some embodiments, the matrix can comprise a mold. In the example of FIG. 2, the matric comprises a mold 200 used to shape keepsake 100. In some examples, mold 200 can comprise a single mold, as is shown in FIG. 2. In other examples, mold 200 can include multiple parts (not shown), thus rendering the final shape of keepsake 100 as more of a complete three-dimensional shape. Any material that is appropriate for being used for the components of keepsake 100 can be used as the mold. As examples, mold 200 can comprise polypropylene, polyethylene, or rubber made from latex, urethane, or silicon. In some instances, it may be appropriate to treat mold 200 with a mold release/conditioner to assist with the release of the casting (keepsake 100) after the keepsake has cured. Mold 200 comprises a cavity 210. Cavity 210 comprises a shape that corresponds to the design of keepsake 100.

In other examples, the matric can comprise an armature (not shown) to shape a sculptured keepsake. For example, if keepsake 100 is created from plaster or concrete, an armature can be used to give keepsake 100 its shape. It should be appreciated that devices other than molds or armatures can be used to shape keepsake 100, including the possibility that no matrix is used. For example, if keepsake 100 is created from clay, the design of keepsake 100 may be entirely formed by freehand.

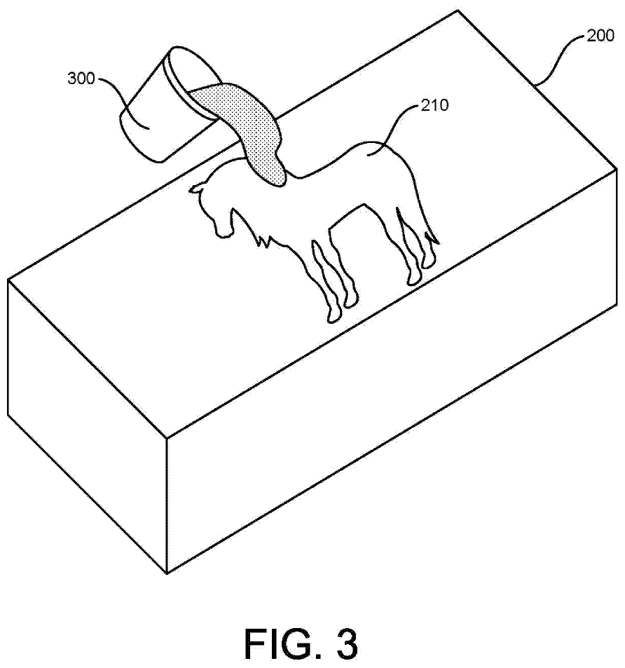

FIG. 3 illustrates an example of a mixture 300 being poured into cavity 210 of mold 200. Mixture 300 comprises the final product mix, or keepsake mixture, that is being used to create keepsake 100, plus the ashes. In one example, mixture 300 comprises a mixture of the resin and the ashes. In other examples, mixture 300 comprises a mixture of plaster or concrete and ashes. In yet other embodiments, mixture 300 can comprise clay and ashes. In some embodiments, mixture 300 can also include additional materials, such as, for example, coloring (dye), metallic powder, crushed glass, glitter, gravel, sand, etc. Any material that is now known to work with keepsake mixtures for decorative purposes, or that becomes known, can be used herein.

If the keepsake is resin, mixture 300 can comprise one part resin and one part hardener. Although, it should be noted that some resins will require different amounts of resin to hardener. For example, some resins may simply require a certain number of drops of a catalyst per so many ounces of resin to harden the resin. The ratio of resin to hardener/catalyst will depend on the resin that is being used. It should be appreciated that any way of creating a resin can be used.

If the keepsake is concrete, mixture 300 can comprise cement, aggregate, and water. The ratios of cement, aggregate, and water can vary, depending on the desired characteristics of the concrete. In some examples, concrete can comprise approximately 10 to 15 percent cement, 60 to 75 percent aggregate, and 15 to 20 percent water. The aggregate can comprise course and fine particles, such as, for example, gravel and sand. In yet other examples, the aggregate can comprise the ash discussed herein as at least a portion of the fine particles in the aggregate. It should be appreciated that any way of creating concrete can be used.

If the keepsake is plaster, mixture 300 can comprise any combination used to create a plaster. For example, a plaster mixture can comprise a combination of water and glue, a combination of flour and water, or a combination of a plaster mixture and water.

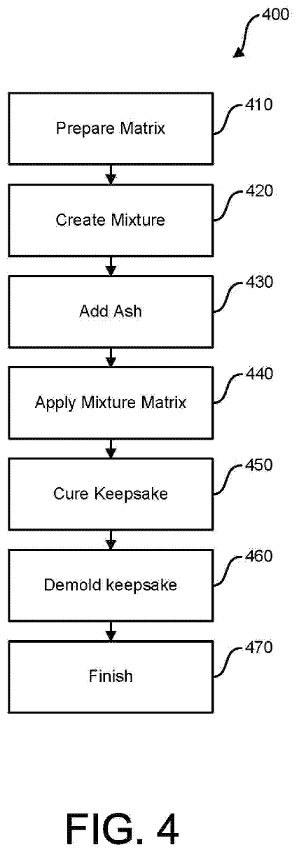

In addition, mixture 300 comprises the cremation ashes. The ashes should be dry before they are mixed into the keepsake mixture. The ratio of keepsake mixture to ash can vary greatly. For example, it may be the desire of the creator of keepsake 100 to add a minimal amount of the ashes to the keepsake mixture. This will have very little effect on the overall mixture 300, such as, for example, altering the color of mixture 300. On the other hand, mixture 300 can comprise a 50/50 ratio of ashes to the keepsake mixture. This will produce a much thicker mixture 300. In some examples, mixture 300 can comprise two times the amount of ashes as keepsake mixture. It should be noted that the ratios mentioned herein are ratios by volume. Further description of the process of creating mixture 300 can be seen below with respect to method 400 (FIG. 4).

After the mixture 300 has been poured into cavity 210 of mold 200, the mixture will need to take some time to cure. Once it is cured, keepsake 100 is created. After keepsake 100 is removed from mold 200, it can be polished, buffed, cut down, painted, recoated with a high gloss finish, etc. for decorative purposes. It should be appreciated, that if an armature is used as the matrix, mixture 300 can be formed on the armature. In some examples, the mixture can be combined with other objects before placing on the armature. For example, if mixture 300 is plaster, pieces of cloth or paper can be placed in mixture 300 before placing the cloth or paper on the armature. It should be appreciated that matrixes other than molds and armature can be used.

FIG. 4 is a flow chart illustrating an example of a method 400 of making a keepsake. In some embodiments, method 400 can be considered a method of making a keepsake comprising ash. In yet other embodiments, method 400 can be considered a method of making a keepsake comprising cremation ash.

Method 400 can include a procedure 410 of preparing a matrix for forming the keepsake. The keepsake can be the same as keepsake 100 (FIG. 1). The matrix, in some implementations can comprise a mold. In such implementations, the mold can be the same as or similar to mold 200 (FIG. 2). In other implementations, the matrix can comprise an armature. In yet other implementation, there may be no matrix. For example, if the keepsake is being sculpted by freehand, there may be no matrix needed. The matrix can comprise any device that is used as a framework to produce the desired shape of the keepsake.

As previously mentioned, any material that is capable of being used for the composition of the keepsake product can be used as the mold. As examples, a mold being prepared under procedure 410 can comprise polypropylene, polyethylene, or rubber made from latex, urethane, or silicon.

Procedure 410 can also include determining the capacity of the mold. It is necessary to determine how much of the keepsake mixture is going to be needed to produce the keepsake. If the mold does not have a capacity listed, then the volume of the cavity in the mold needs to be determined. There are several ways to do this, however, the simplest may be to fill the mold with water and then measure the amount of water that filled the cavity of the mold.

Procedure 410 can also include preparing the mold with a mold release/conditioner. A mold release can allow cast pieces to be removed after the keepsake mixture has cured. In some examples, it may be necessary to treat the mold with more than one application of the mold release.

Next, method 400 continues with a procedure 420 of creating a keepsake mixture. Procedure 420 can comprise combining the various ingredients of the mixture in the proper amounts. For example, to create a desired mixture, it may be necessary to have specific ratios of two or more ingredients. Furthermore, procedure 420 can also comprise mixing the parts of the keepsake mixture together until there is a homogenous mixture.

As one example, if the keepsake mixture is a resin, the ratio of resin to hardener to create the desired resin should be known. The ratio can vary depending on the type of resin that is being created. Such calculations are well known in the art and are not discussed herein. As such, in this example, procedure 420 can comprise pouring of an appropriate amount of resin into a container and then pouring the appropriate amount of hardener into that container. Procedure 420, in this example, can also comprise mixing the resin and the hardener together. Depending on the type of resin being used, the mixing of the ingredients may be different. For example, in some instances, it is necessary to double mix the resin and the hardener. This means that the user should mix the resin and the hardener together thoroughly for a period of time (e.g., 2 minutes) and then pour that mixture into a new separate container. Then the user must mix thoroughly for a second period of time. In other examples, it is unnecessary to double mix, and the resin and the hardener only must be mixed thoroughly once. It is necessary to know the details of the resin that has been chosen to complete procedure 420.

Similarly, in another example, if the keepsake is concrete, procedure 420 can comprise the mixing of cement, aggregate, and water. Once again, the proper ratio of ingredients should be determined by the desired characteristics of the concrete. Furthermore, the type of aggregate used can also determine the characteristics of the concrete. Mixing of ingredients to form concrete and aggregate are well known in the art and, as such, are not discussed here.

In yet another example, if the keepsake is plaster, procedure 420 can comprise the mixing of the various plaster ingredients. Once again, the ingredients and the proper ration of those ingredients can be determined by the type of plaster being used and the desired characteristics of that plaster. In some examples, plaster can also combine an aggregate.

Additionally, there are some examples where there may not be any requirement to prepare the keepsake mixture and, therefore, there will not be any requirement for a procedure 420 to create the keepsake mixture. For example, if the keepsake is made of clay, it is possible to start with clay that is ready to for procedure 430.

Method 400 next comprises a procedure 430 of adding ash to the keepsake mixture to create a final mixture. Procedure 430 can also be considered a procedure of adding cremation ash to the keepsake mixture to create a final mixture. The final mixture can be the same as or similar to mixture 300.

The ratio of ash to keepsake mixture can be determined by the final characteristics desired in the keepsake. The greater amount of ash that is added to the keepsake mixture can increase the thickness of the mixture. Furthermore, the more ash that is combined with the keepsake mixture can affect the color of the keepsake.

The ashes and the resin/hardener mixture need to be mixed thoroughly so that it is as uniform as possible. Adding the ashes to the keepsake mixture can cause bubbles to accumulate in the mixture, especially of the keepsake is resin. This may require the user to add some heated air to the surface to reduce the bubbles, which can affect curing. A blow dryer can be used in such situations. It should be appreciated that a more thorough mixing of the ash and keepsake mixture will produce a final mixture in which the ash is more evenly distributed throughout the keepsake. In some examples, however, it may not be the wish to have an evenly distributed proportion of ash, and therefore, a less thorough mixing may give the keepsake its desire effect.

Procedure 430 can also comprise mixing other elements with the ash and keepsake mixture. As discussed above, this can include, for example, coloring (dye), metallic powder, crushed glass, glitter, gravel, sand, etc., all of which can be used to alter the appearance of the keepsake.

After mixing in the ashes, method 400 continues with procedure 440 of applying the final mixture to the matrix. In many instances, this can comprise pouring (or otherwise placing) the final mixture into a mold. To make the best possible casting, one should make sure that the mold is clean, dry, and level before pouring the mixture into the mold. Once the mixture has been poured, it is best not to pick up or move the mold.

In other examples, an armature may be used to sculpt the keepsake. For example, of the keepsake is made from cement or plaster, it may be desired to create a keepsake that is a sculpture or similar product. In such instances, an armature (or similar framework) can be used to which to apply the final mixture. It should be appreciated that both concrete and plaster can be used in molds also.

In yet other examples, procedure 440 may not be necessary. For example, if the keepsake is to be formed freehand, there will be no need from a matrix to be used.

Once the final mixture has been applied to the matrix, procedure 450 comes next. Procedure 450 comprises curing the keepsake. Curing time will vary depending on the thickness of the mold or sculpture, the room temperature, possibly the amount of ashes, and the type of material used to create the keepsake. A full cure can take anywhere from hours to days. When the keepsake has cured, it may have a hard click when tapped with a stir stick.

Next, method 400 continues with procedure 460 of demolding the keepsake, or removing the cast from the mold, if necessary. If the keepsake is completely cured, you should be able to twist the mold, similar to an ice tray, and push in from the back of the tray to remove the cast. If an armature was used as the matrix, it may not be necessary to remove the keepsake from anything. It should be appreciated that procedure 460 comprises removing the keepsake from anything that is not part of the keepsake or removing anything from the keepsake that is not part of the final keepsake.

Finally, method 400 comprises procedure 470 of finishing the keepsake. This can comprise all the little details to get the cast to be right for a keepsake. Examples of actions that can be taken during procedure 490 can comprise trimming and sanding the keepsake, polishing, buffing, painting, glossing, and other actions, including adding attachments to the keepsake. Upon completion of procedure 470, method 400 should be complete, and a new keepsake comprising the cremation ashes of a loved one or pet has been created.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the resin product and the methods of creating the same discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A keepsake, comprising:
a keepsake mixture;
ashes from the cremation of a deceased human or animal; and
wherein the keepsake is formed using a matrix and the ashes are relatively uniformly distributed throughout the keepsake.

2. The keepsake of claim 1, wherein:
the keepsake mixture comprises a resin.

3. The keepsake of claim 1, wherein:
the keepsake mixture comprises concrete.

4. The keepsake of claim 3, wherein:
the concrete comprises an aggregate; and
the aggregate comprises the ashes.

5. The keepsake of claim 1; wherein:
the keepsake mixture comprises plaster.

6. The keepsake of claim 1, wherein:
the keepsake does not comprise ashes that have not been mixed with the keepsake mixture.

7. A method creating a keepsake; comprising:
choosing a matrix;
creating a keepsake mixture;
thoroughly mixing the keepsake mixture with ashes from the cremation of a deceased human or animal;
applying the mixture of ashes and the keepsake mixture to the matrix; and
allowing mixture of ashes and the keepsake mixture to cure to produce the keepsake;
wherein the keepsake comprises a relatively uniform mixture of the keepsake mixture and ashes throughout the keepsake.

8. The method of claim 7, wherein:
the keepsake mixture comprises a resin.

9. The method of claim 7; wherein:
the keepsake mixture comprises concrete.

10. The method of claim 7; wherein:
the keepsake mixture comprises plaster.

11. The method of claim 7, wherein:
the matrix comprises a mold.

12. The method of claim 7, wherein:
the matrix comprises an armature.

13. The method of claim 7, further comprising altering the appearance of the keepsake after curing.

14. The method of claim 7, further comprising mixing at least one decorative element with the mixture of the ashes and the keepsake mixture.

15. An object, comprising:
a mixture of:
an aggregate; and
a primary mixture comprising at least two components;
wherein the aggregate comprises ashes from the cremation of a deceased human or animal.

16. The object of claim 15, wherein the primary mixture comprises cement and water.

17. The object of claim 15, wherein the at least two components when mixed from a plaster.

18. The object of claim 15, wherein the primary mixture comprises a resin and a hardener.
